(19) United States
(12) Patent Application Publication
(10) Pub. No.: US 2021/0211225 A1
(43) Pub. Date: Jul. 8, 2021

(54) METHODS AND APPARATUS FOR MULTI-INSTANCE CHANNEL STATE INFORMATION REPORTING

(71) Applicant: NEC CORPORATION, Tokyo (JP)

(72) Inventors: Fang YUAN, Beijing (CN); Gang WANG, Beijing (CN)

(73) Assignee: NEC CORPORATION, Tokyo (JP)

(21) Appl. No.: 17/057,407

(22) PCT Filed: May 21, 2018
(86) PCT No.: PCT/CN2018/087632

§ 371 Date: Nov. 20, 2020

(51) Int. Cl. H04L 1/00; H04L 5/00

(52) U.S. Cl. CPC H04L 1/0026; H04L 5/0057

(57) ABSTRACT

Embodiments of the present disclosure relate to methods, devices and apparatuses of multi-instance Channel State Information (CSI) reporting. In an embodiment of the present disclosure, the method may include, in response to a collision of an instance of a CSI report with another CSI report having a higher priority than the instance of CSI report, dropping the instance of the CSI report. The method may further include processing the collision by any one of: discarding all following instances of the CSI report; retransmitting the instance of the CSI report on a next transmission occasion for an instance of the CSI report and transmitting following instances of the CSI report until a new CSI report; continuing transmitting following instance of the CSI report; or retransmitting the instance of the CSI report. With embodiments of the present disclosure, it is possible to support multi-instance CSI reporting for overhead reduction in advanced CSI reporting.

### FIELD OF THE INVENTION

The non-limiting and exemplary embodiments of the present disclosure generally relate to the field of wireless communication techniques, and more particularly relate to methods, devices and apparatuses of multi-instance channel state information (CSI) reporting.

### BACKGROUND OF THE INVENTION

New radio access system, which is also called as NR system or NR network, is the next generation communication system. In Radio Access Network (RAN) #71 meeting for the third generation Partnership Project (3GPP) working group, study of the NR system was approved. The NR system will consider frequency ranging up to 100 Ghz with an object of a single technical framework addressing all usage scenarios, requirements and deployment scenarios defined in Technical Report TR 38.913, which includes requirements such as enhanced mobile broadband, massive machine-type communications, and ultra-reliable and low latency communications.

CSI feedback or reporting, as an import technology in the wireless communication system, could provide information on channel quality from the receiver to the transmitter. In the 3GPP Long Term Evolution (LTE) system, it requires only four bits for CSI feedback, while in Rel. 15 of the NR system, CSI feedback load is signally increased.

FIG. 1 illustrates an example table of Type II CSI feedback overhead in the Rel. 15. From the table, it is clear that the CSI overhead is much higher than 4 bits, even up to nearly hundreds of bits for some cases. Especially, when the L>4 and RI>2 is supported for Type II CSI codebook, the overhead can be further increased.

FIG. 2 illustrates another example table showing reporting formats supported by different CSI. As illustrated in this table, periodical CSI on Physical Uplink Control CHannel (PUCCH) supports only CSI reporting of Type I with wideband (WB), while semi-persistent CSI reporting on Physical Uplink Sharing CHannel (PUSCH) support both Type I and Type II CSI with WB and sub-band (SB) frequency granularities. In addition, it was also proposed to further enhance SP-CSI so that it fully supports Type II CSI. That means a further increase in the CSI overhead. Thus, the CSI overhead issue is required to be addressed.

Thus, in the art, there is a need for an improved solution of the CSI reporting.

### SUMMARY OF THE INVENTION

To this end, in the present disclosure, there is provided a new solution of multi-instance CSI reporting in a wireless communication system, to mitigate or at least alleviate at least part of the issues in the prior art.

According to a first aspect of the present disclosure, there is provided a method for multiple-instance CSI reporting in wireless communication system. The method may include, in response to a collision of an instance of a CSI report with another CSI report having a higher priority than the instance of CSI report, dropping the instance of the CSI report; and processing the collision by any one of: discarding all following instances of the CSI report; retransmitting the instance of the CSI report on a next transmission occasion for an instance of the CSI report and transmitting following instances of the CSI report until a new CSI report; continuing transmitting following instance of the CSI report; or retransmitting the instance of the CSI report with a time offset relative to a transmission occasion for the instance of the CSI report.

According to a second aspect of the present disclosure, there is provided a method for receiving multiple-instance CSI report in wireless communication system. The method may include in case of a collision of an instance of a CSI report with another CSI report having a priority higher than the instance of the CSI report, performing the receiving of the CSI report by any one of: discarding both the instance of the CSI report and all following instances of the CSI report; receiving a retransmission of the instance of the CSI report on a next transmission occasion for an instance of the CSI report and receiving following instances of the CSI report until a new CSI report; discarding the instance of the CSI report and receiving following instance of the CSI report, or receiving a retransmission of the instance of the CSI report with a time offset relative to a transmission occasion for the instance of the CSI report.

According to a third aspect of the present disclosure, there is provided a terminal device, wherein the terminal device is configured for multiple-instance CSI reporting. The terminal device may include a transceiver, and a processor, configured to control the transceiver to, in response to a collision of an instance of a CSI report with another CSI report having a higher priority than the instance of CSI report, drop the instance of the CSI report; and process the collision by any one of: discarding all following instances of the CSI report; retransmitting the instance of the CSI report on a next transmission occasion for an instance of the CSI report and transmitting following instances of the CSI report until a new CSI report; continuing transmitting following instance of the CSI report; or retransmitting the instance of the CSI report with a time offset relative to a transmission occasion for the instance of the CSI report.

According to a fourth aspect of the present disclosure, there is provided a network device, wherein the network device is configured to receive multiple-instance CSI report. The network device may include a transceiver; and a processor, configured to control the transceiver to: in case of a collision of an instance of a CSI report with another CSI report having a priority higher than the instance of the CSI report, perform the receiving of the CSI report by any one of: discarding both the instance of the CSI report and all following instances of the CSI report; receiving a retransmission of the instance of the CSI report on a next transmission occasion for an instance of the CSI report and receiving following instances of the CSI report until a new CSI report; discarding the instance of the CSI report and receiving following instance of the CSI report, and receiving a retransmission of the instance of the CSI report with a time offset relative to a transmission occasion for the instance of the CSI report.

According to a fifth aspect of the present disclosure, there is provided a terminal device. The terminal device may comprise a processor and a memory. The memory may be coupled with the processor and having program codes therein, which, when executed on the processor, cause the terminal device to perform operations of the method according to any embodiment according to the first aspect.

According to a sixth aspect of the present disclosure, there is provided a network device. The network device may comprise a processor and a memory. The memory may be coupled with the processor and have program codes therein, which, when executed on the processor, cause the network device to perform operations of the method according to any embodiment according to the second aspect.

According to a seventh aspect of the present disclosure, there is provided a computer-readable storage media with computer program codes embodied thereon, the computer program codes configured to, when executed, cause an apparatus to perform actions of the method according to any embodiment in the first aspect.

According to an eighth aspect of the present disclosure, there is provided a computer-readable storage media with computer program codes embodied thereon, the computer program codes configured to, when executed, cause an apparatus to perform actions of the method according to any embodiment in the second aspect.

According to a ninth aspect of the present disclosure, there is provided a computer program product comprising a computer-readable storage media according to the seventh aspect.

According to a tenth aspect of the present disclosure, there is provided a computer program product comprising a computer-readable storage media according to the eighth aspect.

With embodiments of the present disclosure, an improved solution for multi-instance CSI reporting is provided, which makes it possible to support multi-instance CSI reporting for overhead reduction in advanced CSI reporting.

### BRIEF DESCRIPTION OF THE DRAWINGS

The above and other features of the present disclosure will become more apparent through detailed explanation on the embodiments as illustrated in the embodiments with reference to the accompanying drawings, throughout which like reference numbers represent same or similar components and wherein:

FIG. 1 illustrates an example table of Type II CSI feedback overhead in the Rel. 15;

FIG. 2 illustrates another example table of reporting formats supported by different CSI;

FIG. 3 schematically illustrates a solution of multi-instance CSI reporting solution in the prior art;

FIG. 4 schematically illustrates another solution of CSI reporting in the prior art;

FIG. 5 schematically illustrates a flow chart of a method for multi-instance CSI reporting at a terminal device according to an embodiment of the present disclosure;

FIG. 6 schematically illustrates an example priority among SB CSI reports;

FIGS. 7A and 7B schematically illustrate diagrams of example collision processing solutions for instance 0 of a CSI report according to embodiments of the present disclosure;

FIG. 8A to 8C schematically illustrate diagrams of example collision processing solutions for instance n (n>0) of a CSI report according to embodiments of the present disclosure;

FIG. 9 schematically illustrates a flow chart of another method for multi-instance CSI reporting at a terminal device according to an embodiment of the present disclosure;

FIG. 10 schematically illustrates a diagram of multi-instance CSI reporting in case of bandwidth part (BWP) switching according to an embodiment of the present disclosure;

FIG. 11A schematically illustrates a flow chart of a method of activation/deactivation for multi-instance CSI reporting at a terminal device according to an embodiment of the present disclosure;

FIG. 11B schematically illustrates a flow chart of a method of configuration for the number of related instances of the CSI report according to an embodiment of the present disclosure;

FIG. 11C schematically illustrates a flow chart of a method of resource allocation for multi-instance CSI reporting at a terminal device according to an embodiment of the present disclosure;

FIG. 12 illustrates a diagram of validity of the activation signaling or the deactivation signaling according to an embodiment of the present disclosure;

FIG. 13 illustrates an example instances in multi-instance CSI reporting for different numbers of instances according to an embodiment of the present disclosure;

FIGS. 14A and 14B schematically illustrate two optional RA patterns for e multi-instance CSI reporting according to embodiments of the present disclosure;

FIG. 15 schematically illustrates a flow chart of a method of sub-band (SB) set configuration for multi-instance CSI reporting according to an embodiment of the present disclosure;

FIG. 16 schematically illustrates activation/deactivation for SB report instances according to an embodiment of the present disclosure;

FIG. 17 schematically illustrates time division multiplexing among instances of the CSI reporting according to an embodiment of the present disclosure;

FIGS. 18A and 18B schematically illustrate two optional SB grouping modes according to embodiments of the present disclosure;

FIGS. 19A and 19B schematically illustrate two optional differential CQI reporting solutions according to embodiments of the present disclosure;

FIG. 20 schematically illustrates a flow chart of a further method of multi-instance CSI reporting according to an embodiment of the present disclosure;

FIG. 21 schematically illustrates an example scenario of multi-instance CSI reporting according to an embodiment of the present disclosure;

FIG. 22 schematically illustrates a flow chart of a still further method of multi-instance CSI reporting according to an embodiment of the present disclosure;

FIG. 23 schematically illustrates a diagram of codeword based multi-instance CSI reporting according to an embodiment of the present disclosure;

FIG. 24 schematically illustrates a flow chart of a method for receiving multi-instance CSI report at a network device according to an embodiment of the present disclosure;

FIG. 25 schematically illustrates a flow chart of another method for receiving multi-instance CSI report at a network device according to an embodiment of the present disclosure;

FIG. 26 schematically illustrates a flow chart of a further method for receiving multi-instance CSI report at a network device according to an embodiment of the present disclosure;

FIG. 27 schematically illustrates a flow chart of a still further method for receiving multi-instance CSI report at a network device according to an embodiment of the present disclosure;

FIG. 28 schematically illustrates a block diagram of an apparatus for multi-instance CSI reporting at a terminal device according to an embodiment of the present disclosure;

FIG. 29 schematically illustrates a block diagram of an apparatus for receiving multi-instance CSI report at a network device according to an embodiment of the present disclosure; and

FIG. 30 schematically illustrates a simplified block diagram of an apparatus 3010 that may be embodied as or comprised in a terminal device like UE, and an apparatus 3020 that may be embodied as or comprised in a network device like gNB as described herein.

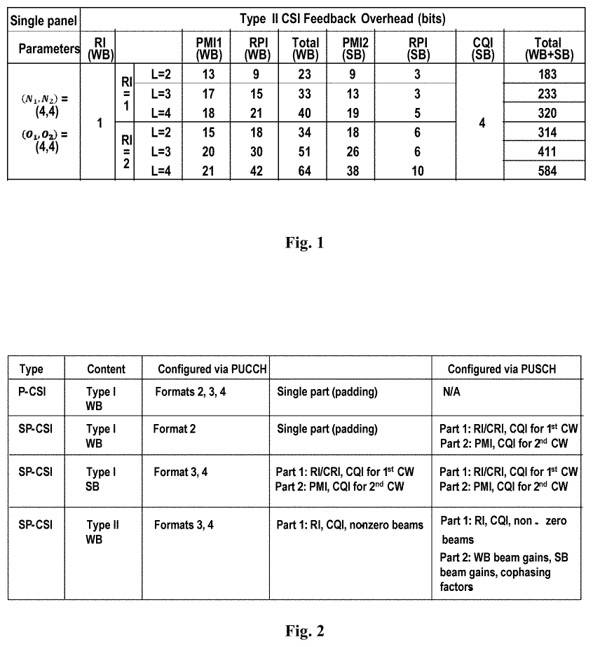

### DETAILED DESCRIPTION OF EMBODIMENTS

Hereinafter, the solution as provided in the present disclosure will be described in details through embodiments with reference to the accompanying drawings. It should be appreciated that these embodiments are presented only to enable those skilled in the art to better understand and implement the present disclosure, not intended to limit the scope of the present disclosure in any manner.

In the accompanying drawings, various embodiments of the present disclosure are illustrated in block diagrams, flow charts and other diagrams. Each block in the flowcharts or blocks may represent a module, a program, or a part of code, which contains one or more executable instructions for performing specified logic functions, and in the present disclosure, a dispensable block is illustrated in a dotted line. Besides, although these blocks are illustrated in particular sequences for performing the steps of the methods, as a matter of fact, they may not necessarily be performed strictly according to the illustrated sequence. For example, they might be performed in reverse sequence or simultaneously, which is dependent on natures of respective operations. It should also be noted that block diagrams and/or each block in the flowcharts and a combination of thereof may be implemented by a dedicated hardware-based system for performing specified functions/operations or by a combination of dedicated hardware and computer instructions.

Generally, all terms used in the claims are to be interpreted according to their ordinary meaning in the technical field, unless explicitly defined otherwise herein. All references to “a/an/the/said [element, device, component, means, step, etc.]” are to be interpreted openly as referring to at least one instance of said element, device, component, means, unit, step, etc., without excluding a plurality of such devices, components, means, units, steps, etc., unless explicitly stated otherwise. Besides, the indefinite article “a/an” as used herein does not exclude a plurality of such steps, units, modules, devices, and objects, and etc.

Additionally, in a context of the present disclosure, user equipment (UE) may refer to a terminal, a Mobile Terminal (MT), a subscriber station, a portable subscriber station, Mobile Station (MS), or an Access Terminal (AT), and some or all of the functions of the UE, the terminal, the MT, the SS, the portable subscriber station, the MS, or the AT may be included. Furthermore, in the context of the present disclosure, the term “BS” may represent, e.g., a node B (NodeB or NB), an evolved NodeB (eNodeB or eNB), gNB (next generation Node B), a radio header (RH), a remote radio head (RRH), a relay, or a low power node such as a femto, a pico, and so on.

As mentioned in Background, in Rel. 15 of the NR system, CSI feedback load is signally increased, even up to nearly six hundred bits and thus CSI overhead issue is required to be addressed.

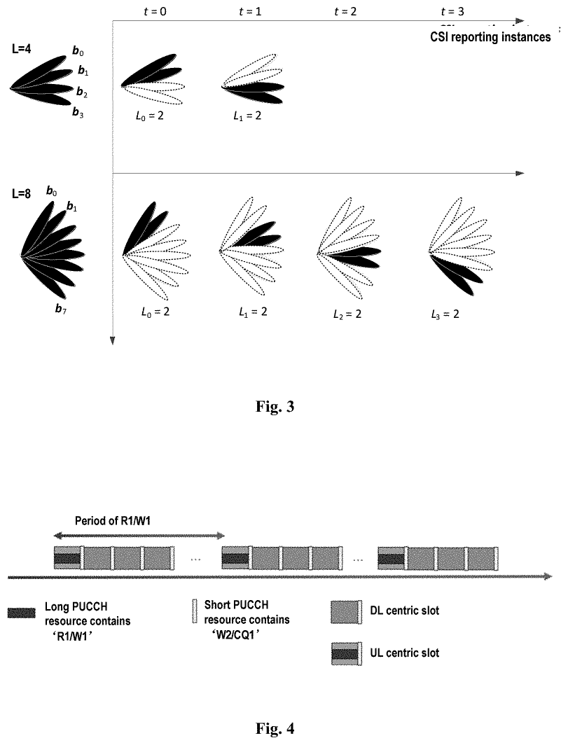

In 3GPP technical document R1-1710673, there was provided a solution of differential report for Type II CSI. In the solution, the CSI report contains one WB CSI report for W1 (wideband) and T SB CSI reports for W2 (subband). For the SB CSI reports, a multi-instance CSI reporting solution was proposed, wherein beams to be reported are decomposed into T beam groups and their CSI are reported in T instances. As illustrated in FIG. 3, each beam group contains 2 beams, it requires two instances if there are four beams to be reported and requires four instances if there are eight beams to be reported. In the proposed solution, each SB CSI on a beam group is self-decodable, which means it is independent of CSI on any other beam group, and a higher-resolution CSI can be resulted from a linear sum of T lower-resolution CSI.

In 3GPP technical document R1-1711165, it was also provided a solution of CSI reporting on PUCCH. In the solution, it was proposed to use the long duration PUCCH to transmit long-term feedback like channel state information-reference signal resource indicator (CRI), Rank Indicator (RI), W1, or the like, use short duration PUCCH to transmit short term feedback like W2, channel quality indication (CQI), or the like, as illustrated in FIG. 4.

In 3GPP technical document R1-1710454, it was further disclosed several options of reducing CSI overhead within one time instance. In the proposed solution, three possible options are provided:
Option 1: Reporting of the CSI of each layer can be multiplexed in time domain, and CSI of each layer is reported within one time instance.
Option 2: Reporting of the CSI of each layer can be multiplexed in time domain, and CSI of each layer is reported in multiple time instances.
Option 3: CSI of multiple layers can be reported in multiple time instances, and reported CSI in each time instance is from all the layers.

In patent application publication WO2018/029644A2, there was disclosed a solution of progressive advanced CSI Feedback. In the solution, it was proposed to transmit CSI of a first beam in the first report instance and transmit CSI of a second beam with co-phasing factor in a second report instance, and the CSI report instances can be transmitted in response to the request from a network node.

Although several solutions of multi-instance CSI reporting were already proposed, but it is still unclear how to support the multi-instance CSI reporting and at the same time overhead reduction is needed for advanced CSI reporting. To this end, in the present disclosure, there is proposed an improved solution to address or at least alleviate at least some of these issues.

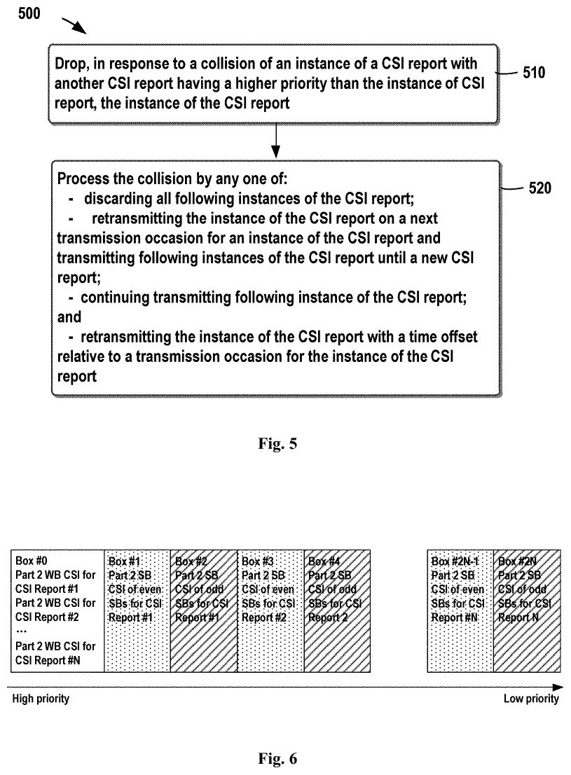

Hereinafter, reference will be further made to FIGS. 5 to 30 to describe solutions as proposed in the present disclosure in details. However, it shall be appreciated that following embodiments are given only for illustrative purposes and the present disclosure is not limited thereto. Especially, different embodiments as described herein can be implemented alone and separately or combined in any suitable manner as long as it is feasible from a point of the technical view.

FIG. 5 schematically illustrates a flow chart of a method for multi-instance CSI reporting at a terminal device according to an embodiment of the present disclosure. The method 500 may be performed at a terminal device, for example a terminal device like UE, or other like devices.

As illustrated in FIG. 5, in step 510, in response to a collision of an instance of a CSI report with another CSI report having a higher priority than the instance of CSI report, the UE drops the instance of the CSI report. In other words, in embodiments of the present disclosure, in a case of a conflict among CSI reports, only an instance of CSI report with a higher priority can be transmitted, while an instance of CSI with a lower priority will be dropped.

In Rel. 15, priority among CSI reports was defined, which could be expressed as:

Pri_{tCSI}(y,k,c,s)=2·N_{cells}·Mₛ·y+N_{cells}·Mₛ·k+Mₛ·c+s (1)

wherein
i denotes index of the CSI report;
y=0 for aperiodic CSI reports to be carried on PUSCH, y=1 for semi-persistent CSI to be carried on PUSCH, y=2 for semi-persistent CSI to be carried on PUCCH, y=3 for periodic CSI to be carried on PUCCH;
k=0 for CSI reports carrying L1-RSRP, and k=1 for CSI reports not carrying L1-RSRP;
c denotes the serving cell index;
s denotes the report configuration identification ReportConfigID and
N_{cells} denotes the number of cells;
Mₛ denotes the value of the higher layer parameter maxNrofCSI-Reports.

Based on the above equation, it could determine the priority of CSI reports and in turn determine whether the instance of the CSI report has a higher or lower priority than the other CSI report.

FIG. 6 further illustrates a diagram of priority within a part 2 of the CSI report, from which it can be seen that, the priority decreases from the left to the right. Based on the priority setting, it is possible to determine whether the instance of the CSI report for part 2 has a higher or lower priority than the other CSI report and, in turn, determines whether to transmit the instance of the CSI report.

Reference is made back to FIG. 5, in step 520, the UE may process the collision by any one of various actions. The various actions may include discarding all following instances of the CSI report; retransmitting the instance of the CSI report on a next transmission occasion for an instance of the CSI report and transmitting following instances of the CSI report until a new CSI report; continuing transmitting following instance of the CSI report; and retransmitting the instance of the CSI report with a time offset relative to a transmission occasion for the instance of the CSI report.

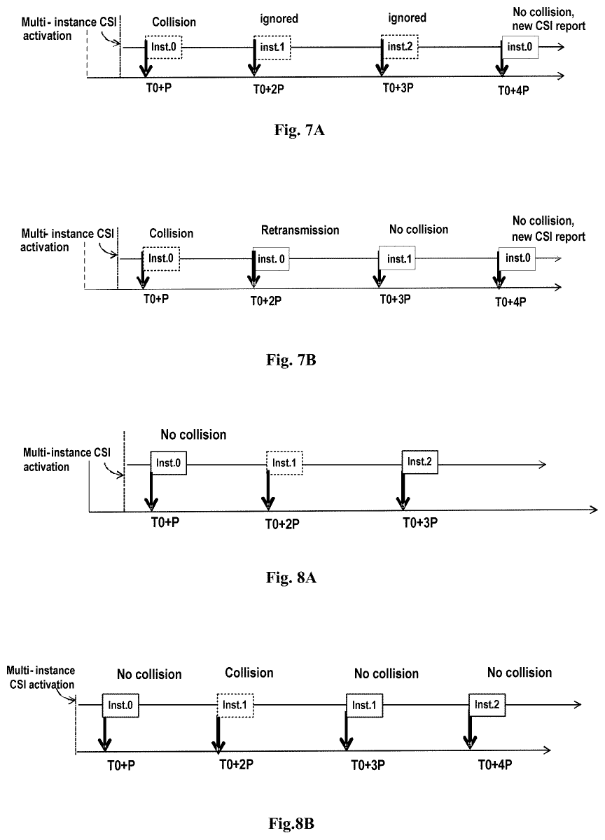

In an embodiment of the present disclosure, the UE may discard all following instances of the CSI report if the instance of the CSI report has a conflict with the other CSI report and is dropped. FIG. 7A schematically illustrates a diagram of an example collision processing solution for instance 0 of a CSI report according to an embodiment of the present disclosure. As illustrated, if instance 0 has a collision with another CSI report, instance 0 will be dropped and other following instances instance 1, instance 2 will be discarded or ignored until a new CSI report if there is no any collision.

In another embodiment of the present disclosure, the UE may retransmit the instance of the CSI report on a next transmission occasion for an instance of the CSI report and transmitting following instances of the CSI report until a new CSI report. FIG. 7B schematically illustrates a diagram of another example collision processing solution for instance 0 of a CSI report according to an embodiment of the present disclosure. As illustrated, if instance 0 has a collision with another CSI report, instance 0 will be retransmitted on the following instance transmission occasion (which would have been used for instance 1) and the following instances of the CSI will be also transmitted until a new CSI report if there is no any collision. Thus, in this embodiment of the present application, some instances of the CSI report (such as instance 2 of the CSI report) might have no opportunity to be transmitted and thus be ignored or discarded.

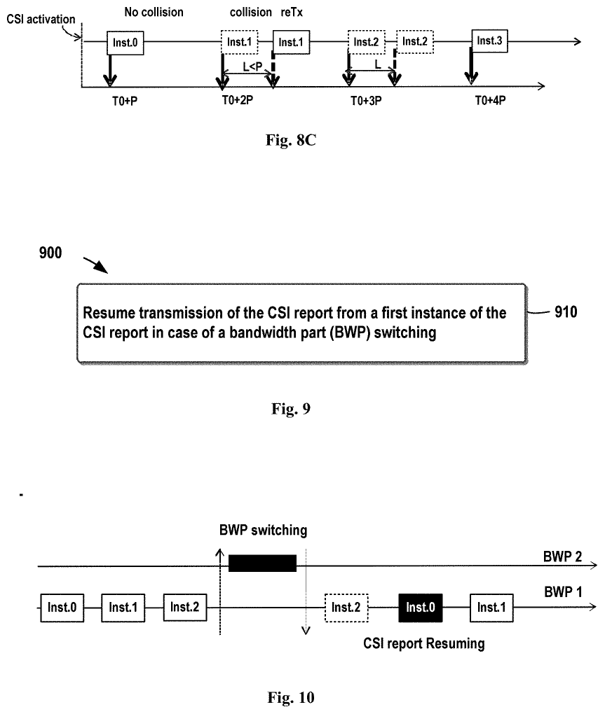

In a further embodiment of the present disclosure, the UE may continue transmitting following instance of the CSI report with the collided instance dropped. FIG. 8A schematically illustrates a diagram of an example collision processing solution for instance n (n>0) of a CSI report according to an embodiment of the present disclosure. As illustrated, if instance 1 has a collision with another CSI report, instance 1 will be dropped and the following instance 2 will be transmitted on the following instance transmission occasions as usual.

In a still further embodiment of the present disclosure, the UE may retransmit the instance of the CSI report on a next transmission occasion for an instance of the CSI report and transmitting following instances of the CSI report until a new CSI report. FIG. 8B schematically illustrates a diagram of another example collision processing solution for instance n (n>0) of a CSI report according to an embodiment of the present disclosure. As illustrated, if instance 1 has a collision with another CSI report, instance 1 will be retransmitted on the following instance transmission occasion (which would have been used for instance 2) and the following instance 2 of the CSI will be also transmitted until a new CSI report if there is no any collision. Thus, in this embodiment of the present application, similar to the collision addressing for instance 0, some instances of the CSI report (such as an instance (not shown) following instance 2 of the CSI report, if any) might have no opportunity to be transmitted and thus be ignored or discarded.

In a further embodiment of the present disclosure, the UE may retransmit the instance of the CSI report with a time offset relative to a transmission occasion for the instance of the CSI report. FIG. 8C schematically illustrates a diagram of a further example collision processing solution for instance n (n>0) of a CSI report according to an embodiment of the present disclosure. As illustrated, if instance 1 has a collision with another CSI report, instance 1 will be dropped and retransmitted at a timing determined by the transmission occasion for the instance of the CSI report and a predetermined time offset L. The time offset L is shorter than the periodicity P of instances of the CSI report, or the time interval P between the transmission occasion T0+2P for the instance of the CSI report and the transmission occasion T0+3P for the immediately next instance of the CSI report. In such a way, the following instances of the CSI report will not be influenced, as illustrated in FIG. 8C. If instance 2 has a collision with another CSI report, the UE could retransmit instance 2 by a time offset; if instance 2 further has a collision with other CSI report in the retransmission occasion, the UE could just discard instance 2 as illustrated.

In a different aspect of the present disclosure, there is further proposed another method for multi-instance CSI reporting in case of BWP switching. Reference is made to FIG. 9 to describe an example embodiment of the present disclosure.

FIG. 9 schematically illustrates a flow chart of another method for multi-instance CSI reporting at a terminal device according to an embodiment of the present disclosure. The method 900 may be performed at a terminal device, for example a terminal device like UE, or other like devices.

As illustrated in FIG. 9, in step 910, the UE may resume a transmission of the CSI report from a first instance of the CSI report in case of a bandwidth part (BWP) switching. As illustrated in FIG. 10, after the BWP switching, different BWP 2 will be used and in such a case, when the BWP is switched back to BWP1, it requires resuming the CSI reporting. In such a case, the UE may resume transmission of the CSI report for instance 0 at a corresponding scheduled occasion and discard all instances (such as instance 2) which were scheduled to report except instance 0, before resuming the transmission. In other words, in any case, the UE could resume a transmission of the CSI report from instance 0 of the CSI report as long the BWP switching occurs.

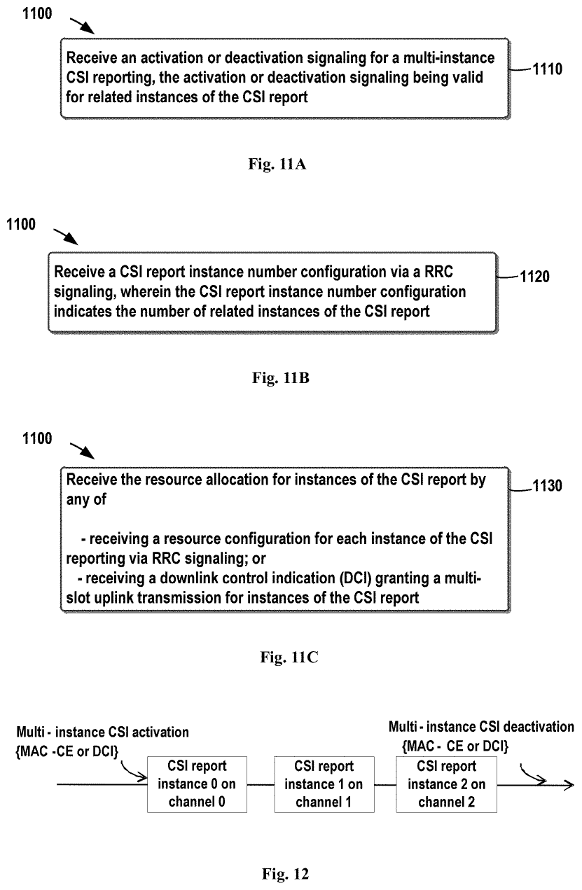

In a further aspect of the present disclosure, there is further proposed a solution of configuration or resource allocation for multi-instance CSI reporting. Reference will be made to FIGS. 11A to 11C to describe an example embodiment of the present disclosure. The method 1100 as illustrated in FIG. 11A may be performed at a terminal device, for example a terminal device like UE, or other like devices.

The skilled in the art could understand that different steps illustrated in FIGS. 11A to 11C are unnecessary to be implemented in a single embodiment of the present disclosure. In fact they could be implemented in various combinations or can be implemented separately in different embodiments of the present disclosure. In other words, these operations in various steps are not necessarily bound together but could be implemented independently.

FIG. 11A schematically illustrates a flow chart of a method of activation of deactivation for multi-instance CSI reporting at a terminal device according to an embodiment of the present disclosure.

As illustrated in FIG. 11A, in step 1110, the UE may receive a single activation/deactivation signaling for the multi-instance CSI reporting, wherein the activation/deactivation signaling could be valid for related instances of the CSI report.

The multi-instance CSI reporting could be supported in for example SP-CSI reporting whose CSI overhead is remarkably high. In an embodiment of the present disclosure, if the CSI report is to be carried on the PUCCH, the activation/deactivation signaling can be implemented by Media Access Control-Control Element (MAC-CE). In another embodiment of the present disclosure, if the CSI report is to be carried on the PUSCH, the activation/deactivation signaling can be implemented by a downlink control indication (DCI) signaling.

In embodiments of the present disclosure, for the activation signaling or the deactivation signaling for the multi-instance CSI reporting, it is applicable to all instances of the CSI report. FIG. 12 illustrates a diagram of validity of the activation signaling or the deactivation signaling according to an embodiment of the present disclosure. As illustrated in FIG. 12, upon of receiving a multi-instance CSI activation signaling, the UE will use a plurality instances to report the CSI and the UE stop using the multi-instance CSI reporting upon receiving a multi-instance CSI deactivation signaling.

In an embodiment of the present disclosure, the number of related instances of the CSI report can also be configured by the network device. FIG. 11B illustrates a flow chart of a method of configuration for the number of related instances of the CSI report according to an embodiment of the present disclosure. The method 1100 as illustrated in FIG. 11B may be performed at a terminal device, for example a terminal device like UE, or other like devices.

As illustrated in FIG. 11B, in step 1120, the UE may receive a CSI report instance number configuration via a RRC signaling, wherein the CSI report instance number configuration indicates the number of related instances of the CSI report.

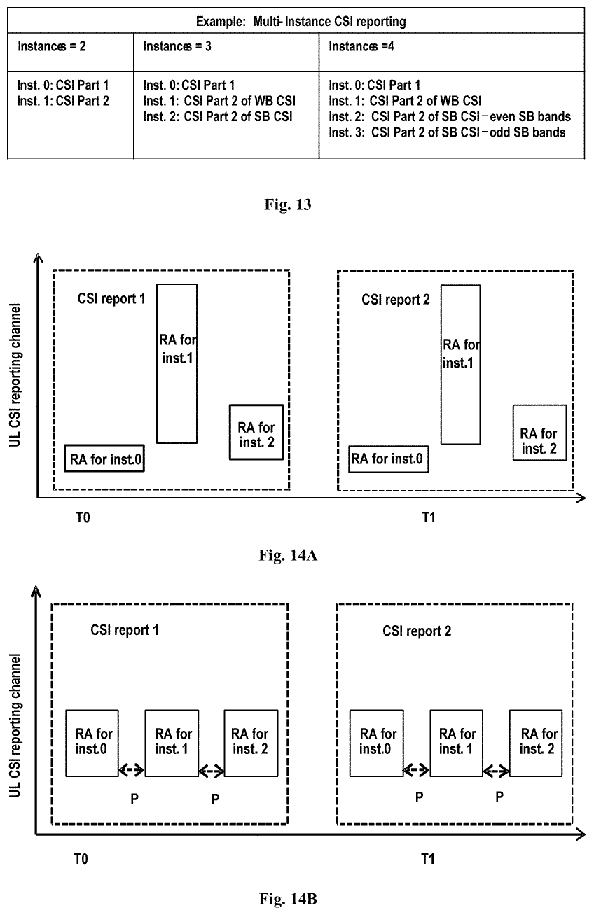

In an embodiment of the present disclosure, for different instance number configurations, the CSI report could be decomposed in different ways. For illustrative purposes, FIG. 13 illustrates example Multi-instance CSI reporting for different numbers of instances according to an embodiment of the present disclosure. As illustrated in FIG. 13 for a type II CSI report, if the number of instances is two, instance 0 could contain CSI part 1 and instance 1 could contain CSI part 2; if the number of instances is three, instance 0 could contain CSI part 1, instance 1 could contain CSI part 2 of WB CSI and instance 2 could contain CSI part 2 of SB CSI; if the number of instances is four, instance 0 could contain CSI part 1, instance 1 could contain CSI part 2 of WB CSI, instance 2 could contain CSI part 2 of SB CSI for even SB bands, instance 2 could contain CSI part 2 of SB CSI for odd SB bands.

In another embodiment of the present disclosure, the network device could allocate resource for CSI report instances used in multi-instance CSI reporting. FIG. 11C schematically illustrates a flow chart of a method of resource allocation for multi-instance CSI reporting at a terminal device according to an embodiment of the present disclosure. The method 1100 as illustrated in FIG. 11C may be performed at a terminal device, for example a terminal device like UE, or other like devices.

As illustrated in FIG. 11C, in step 1130, the UE may receive resource allocation for instances of the CSI report. In an embodiment of the present disclosure, the UE may receive a resource configuration for each instance of the CSI reporting via RRC signaling. In another embodiment of the present disclosure, the UE may receive a downlink control indication (DCI) which grants a multi-slot uplink transmission for instances of the CSI report.

In an embodiment of the present disclosure, the resource allocation (RA) for the multi-instance CSI reporting may be non-uniform. As illustrated in FIG. 14A, the RA for instances 0, 1 and 2 could be different in any of size, or frequency domain location. While for different CSI reports, RA for the same instance has same size and frequency domain locations.

For illustrative purposes, a RRC signaling for configuration of non-uniform RA is given as follows:

semiPersistentOnPUCCH_mult SEQUENCE {

| | |
|---|---|
| semiPersistentOnPUCCH_instances | SEQUENCE |

(size(1..NrofIntances))semiPersistentOnPUCCH
};
semiPersistentOnPUCCH SEQUENCE {

reportSlotConfig CSI-ReportPeriodicityAndOffset,
pucch-CSI-ResourceListSEQUENCE (SIZE (1..maxNrofBWPs)) OF

PUCCH-CSI-Resource
}

In an embodiment of the present disclosure, the RA for the multi-instance CSI reporting may be uniform. In other words, they could have the same resource size, occupy the same frequency domain location and have a predetermined periodicity P. As illustrated in FIG. 14B, the RA for instances 0, 1 and 2 are same in size and occupy the same frequency domain location and have a periodicity P. Meanwhile, for different CSI reports, they have the same RA pattern.

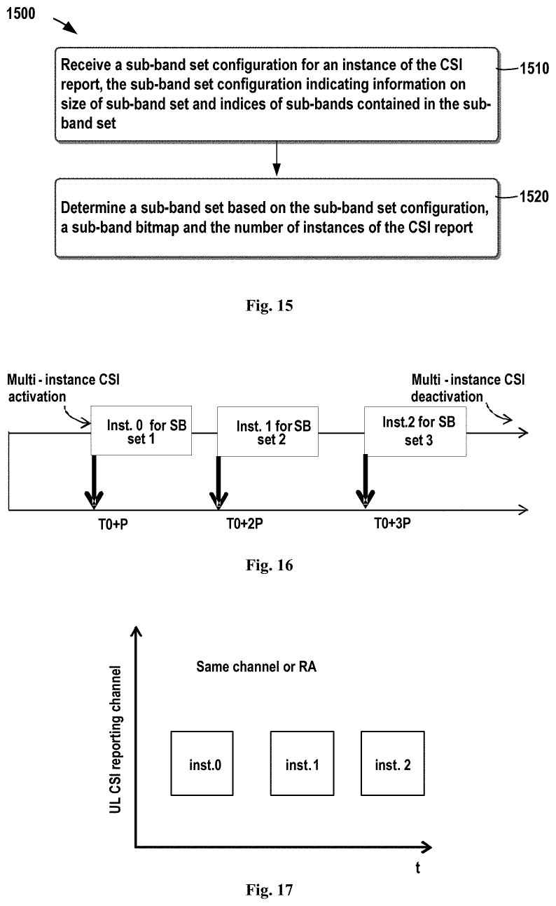

In a further aspect of the present disclosure, the CSI report can be performed based on sub-band set. In other words, one instance of a CSI report will contain CSI corresponding to a sub-band set. Such a sub-band set could be configured by the network device or determined by the terminal device, which will be described in more details with reference to FIGS. 15 to 17.

FIG. 15 schematically illustrates a flow chart of a method of SB set configuration for multi-instance CSI reporting according to an embodiment of the present disclosure. The method 1500 may be performed at a terminal device, for example a terminal device like UE, or other like devices.

As illustrated in FIG. 15, in step 1510, the UE may receive a sub-band set configuration for an instance of the CSI report, the sub-band set configuration indicating information on size of sub-band set and indices of sub-bands contained in the sub-band set. For illustrative purposes, an example RRC signaling of the sub-band set configuration is given as follow:

semiPersistentOnPUCCH_mult SEQUENCE {

semiPersistentOnPUCCH_instances SEQUENCE (size(1..NrofIntances))

semiPersistentOnPUCCH

},

semiPersistentOnPUCCH SEQUENCE {

| | |
|---|---|
| reportSlotConfig | CSI-ReportPeriodicityAndOffset, |

pucch-CSI-ResourceList SEQUENCE (SIZE (1..maxNrofBWPs)) OF

PUCCH-CSI-Resource

| | |
|---|---|
| csi-ReportingSub-band Set | BIT STRING(SIZE(X)) |

}

In an embodiment of the present disclosure, one activation/deactivation signaling can be also valid for more than one SB report instances, as illustrated in FIG. 16. In another embodiment of the present disclosure, each instance of the CSI reporting can be time division multiplexed to the same reporting channel or use the same RA, as illustrated in FIG. 17. In an embodiment of the present disclosure, respective reporting SB instances could have priorities independent of each. In addition, in another embodiment of the present disclosure, retransmission is not allowed for each instance.

Reference is made back to FIG. 15. As illustrated in step 1520, the UE may determine a sub-band set based on the sub-band set configuration, a sub-band bitmap and the number of instances of the CSI report. Based on the sub-band set configuration from the network device, the sub-band bitmap which is already known by the terminal device, and the instance number configuration of the CSI report, the UE could determine the SB set whose CQI to be reported.

In an embodiment of the present disclosure, WB CSI (RI/CQI/Precoding Matrix indicator (PMI)) contained in each instance could be conditioned on the SB set. In another embodiment of the present disclosure, an SB CQI/PMI is optionally reported in each SB in the SB set. In addition, RI could assume the same value over all the instances in a CSI report. As an alternative option, RI could assume a different value over all instances in the CSI report.

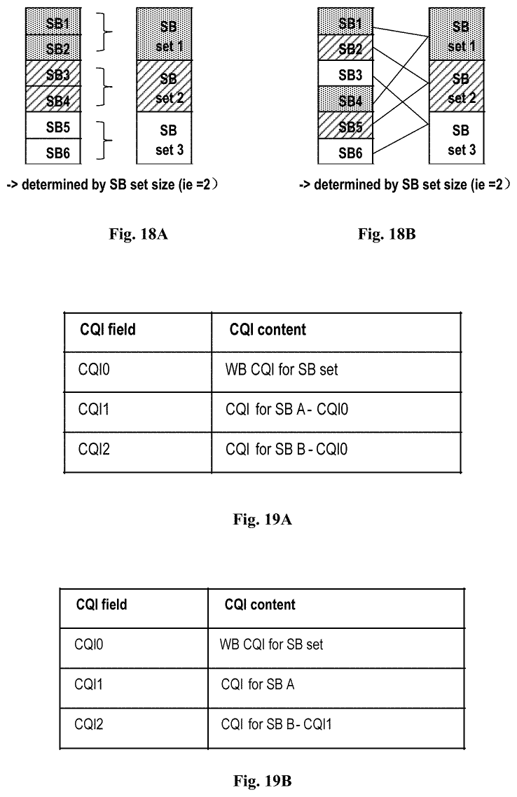

FIGS. 18A and 18B schematically illustrate two optional SB grouping modes according to embodiments of the present disclosure. As illustrated in FIG. 18A, in Mode A, the SB set is formed by adjacent sub-bands, which can be determined by the size of an SB set. As illustrated in FIG. 18B, in Mode B, the SB set is formed by SBs in a comb-like pattern, where a SB set can be indexed by a ratio factor and an offset value. For example, for 3 combs, a ratio factor 1/3 could be used and the first, second and third SB sets could have an offset value of 0, 1, and 2, respectively.

In an embodiment of the present disclosure, it may assume a differential CQI reporting solution in instances of the CSI report. For illustrative purposes, FIGS. 19A and 19B schematically illustrate two optional different CQI reporting solutions according to embodiments of the present disclosure. As illustrated in FIG. 19A, for three instances, CQI 0 could contain WB CQI for SB set, and both CQI1 and CQI2 could contain differential CQI relative to CQI0. As illustrated in FIG. 19B, different from the solution in FIG. 19A, only CQI 2 could contain differential CQI relative to CQI 1.

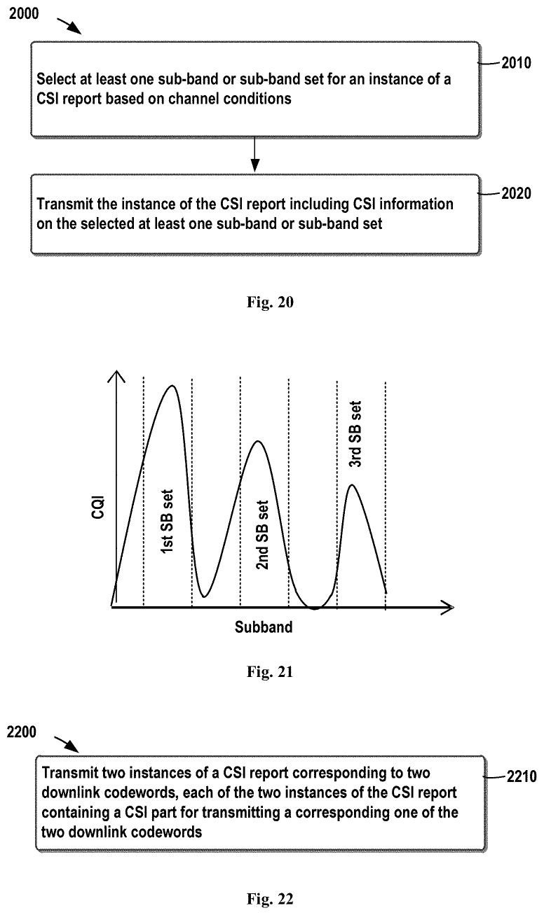

In a further aspect of the present disclosure, it is proposed to select, by UE, an SB or SB set for each CSI reporting instance, instead of configuring the SB set by the network device. FIG. 20 schematically illustrates a flow chart of a further method of multi-instance CSI reporting according to an embodiment of the present disclosure. The method 2000 may be performed at a terminal device, for example a terminal device like UE, or other like devices.

As illustrated in FIG. 20, the UE may select at least one sub-band or sub-band set for an instance of a CSI report based on channel conditions. FIG. 21 schematically illustrates an example scenario of multi-instance CSI reporting according to an embodiment of the present disclosure. As illustrated in FIG. 21, the UE could know the channel conditions, and based thereon, it could select for example three SB set with better channel qualities for CSI reporting. Then, in step 3020, the UE may transmit the instance of the CSI report including CSI information on the selected at least one sub-band or sub-band set.

In an embodiment of the present disclosure, the activation/deactivation signaling could enable UE to select an SB report for each instance. The selection of the SB set could be informed to the network device in uplink control indication (UCI). For example, the UCI in each reporting instance may contain an SB identification or an SB set identification.

In an embodiment of the present disclosure, the WB CSI for SB (set) may contain RI/WB CQI/WB PMI, and the SB CSI for SB may contain SB CQI/PMI. In addition, RI could assume the same value over all the instances in a CSI report. Or alternatively, RI could use different values over all the instances in a CSI report.

In a yet further aspect of the present disclosure, the multi-instance CSI reporting can be performed based on codewords (or transport blocks). In other words, the CSI instances can be reported per codeword (or per transport block). FIG. 22 schematically illustrates a flow chart of a still further method of multi-instance CSI reporting according to an embodiment of the present disclosure. The method 2200 may be performed at a terminal device, for example a terminal device like UE, or other like devices.

As illustrated in FIG. 22, in step 2210, the UE may transmit two instances of a CSI report corresponding to two downlink codewords, each of the two instances of the CSI report containing a CSI part for transmitting a corresponding one of the two downlink codewords.

FIG. 23 schematically illustrates a diagram of codeword based multi-instance CSI reporting according to an embodiment of the present disclosure. As illustrated in FIG. 23, the CSI report may include two instances for two codewords, instance 0 and instance 1. Instance 0 contains a CSI part to be used by the network device to transmit a first codeword (i.e., DL codeword A), and instance 1 contains a CSI part to be used by the network device to transmit a second codeword (i.e., DL codeword B). Particularly, each of instance 0 and instance 1 could contain UCI of RI/WB, CQI/WB or PMI, and optionally, may further contain SB CQI/SB PMI for the associated codeword.

In an embodiment of the present disclosure, two codewords may be transmitted from different transmission/reception points (TRP). In another embodiment of the present disclosure of the present disclosure, two codewords may be transmitted from different downlink layers of the same TRP. For example, codeword A is transmitted from layers 1-4 of a TRP and codeword B is transmitted from layers 5 to 7 of the same TRP.

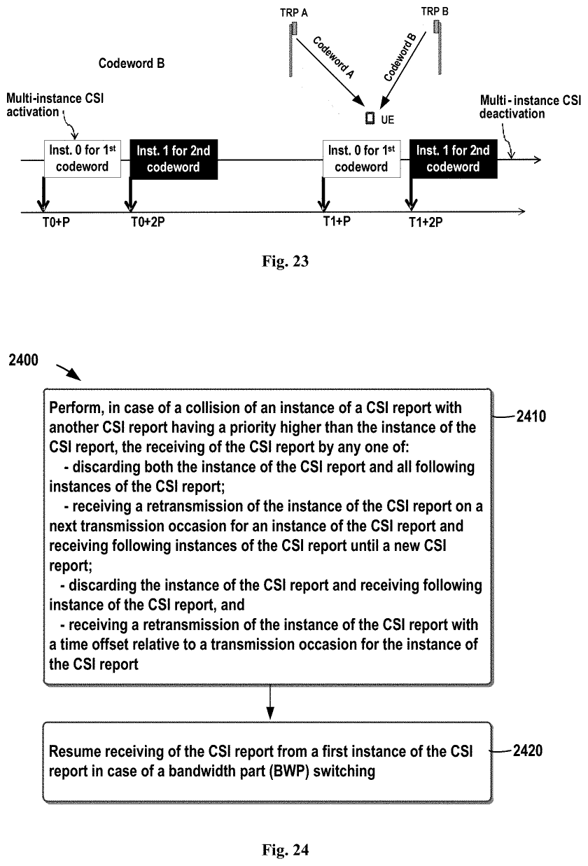

Next, reference will be made to FIGS. 24 to 27 to describe example methods of receiving multi-instance CSI report at the network device according to embodiments of the present disclosure.

FIG. 24 schematically illustrates a flow chart of a method for receiving multi-instance CSI report at a network device according to an embodiment of the present disclosure. The method 2400 may be performed at a network device, for example a base station like gNB, or other like devices.

As illustrated in FIG. 24, in step 2410, in case of a collision of an instance of a CSI report with another CSI report having a priority higher than the instance of the CSI report, the gNB may perform receiving of the CSI report by any one of various actions The actions may include: discarding both the instance of the CSI report and all following instances of the CSI report; receiving a retransmission of the instance of the CSI report on a next transmission occasion for an instance of the CSI report and receiving following instances of the CSI report until a new CSI report; discarding the instance of the CSI report and receiving following instances of the CSI report, or receiving a retransmission of the instance of the CSI report with a time offset relative to a transmission occasion for the instance of the CSI report.

In an embodiment of the present disclosure, the method 2400 may alternatively or additionally include resuming receiving of the CSI report from a first instance of the CSI report in case of a BWP switching.

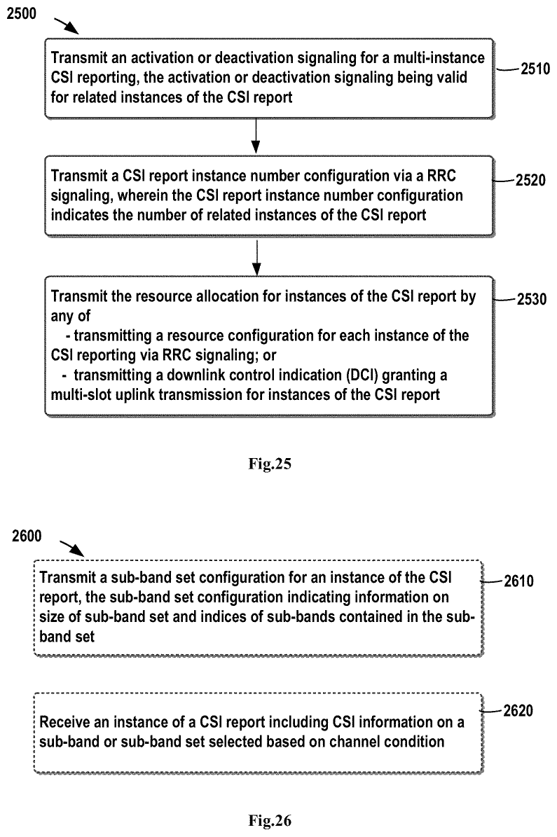

In a different aspect of the present disclosure, there is further proposed another method for configuration or resource allocation for multi-instance CSI reporting. Reference is made to FIG. 25 to describe an example embodiment of the present disclosure.

FIG. 25 schematically illustrates a flow chart of another method for receiving multi-instance CSI report at a network device according to an embodiment of the present disclosure. The method 2500 may be performed at a network device, for example a base station like gNB, or other like devices.

As illustrated in FIG. 25 in step 2510, the gNB may transmit an activation or deactivation signaling for a multi-instance CSI reporting, the activation or deactivation signaling being valid for related instances of the CSI report. Alternatively or additionally, in step 2520, the gNB may transmit a CSI report instance number configuration via a RRC signaling, wherein the CSI report instance number configuration indicates the number of related instances of the CSI report. As further illustrated in FIG. 25, in step 2530, the gNB may transmit resource allocation for instance of the CSI report. In an embodiment of the present disclosure, the transmission of the resource allocation may be implemented by transmitting a resource configuration for each instance of the CSI reporting via RRC signaling. In another embodiment of the present disclosure, the gNB may transmit a downlink control indication (DCI) granting a multi-slot uplink transmission for instances of the CSI report.

In a further different aspect of the present disclosure, the CSI report can be performed based on sub-band set. In other word, one instance of a CSI report will contain CSI of a corresponding sub-band set. Such a sub-band set could be configured by the network device or determined by the terminal device, which will be described in more details with reference to FIG. 26.

FIG. 26 schematically illustrates a flow chart of a further method for receiving multi-instance CSI report at a network device according to an embodiment of the present disclosure. The method 2600 may be performed at a network device, for example a base station like gNB, or other like devices.

As illustrated in FIG. 26, in step 2610, the gNB may transmit a sub-band set configuration for an instance of the CSI report, the sub-band set configuration indicating information on size of sub-band set and indices of sub-bands contained in the sub-band set. Alternatively, stead of configuring the SB set from the network device, the UE may select at least one sub-band or sub-band set for an instance of a CSI report based on channel conditions. In such a case, the gNB may receive an instance of a CSI report including CSI information on a sub-band or sub-band set selected based on channel conditions, as illustrated in step 2620.

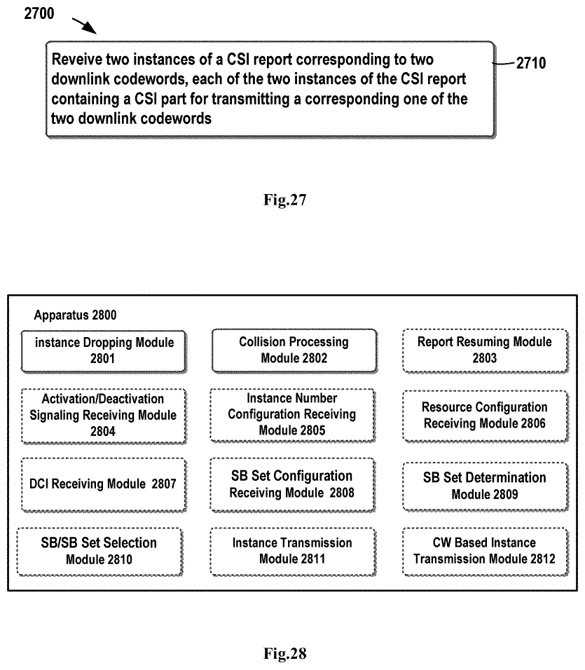

In a yet further aspect of the present disclosure, the multi-instance CSI reporting can be performed based on codewords. In other words, the CSI instances can be reported per codeword, which will be described with reference to FIG. 27.

FIG. 27 schematically illustrates a flow chart of a still further method for receiving multi-instance CSI report at a network device according to an embodiment of the present disclosure; The method 2700 may be performed at a network device, for example a base station like gNB, or other like devices.

As illustrated in FIG. 27 in step 2710, the gNB may receive two instances of a CSI report corresponding to two downlink codewords, each of the two instances of the CSI report containing a CSI part for transmitting a corresponding one of the two downlink codewords. The gNB can obtain the CSI part contained in the two instances and transmitting the codeword according to the CSI contained respective CSI parts.

In an embodiment of the present disclosure, the gNB may transmit the two downlink codewords from different downlink layers of the same transmission/reception point (TRP). In another embodiment of the present disclosure, the gNB may transmit the two downlink codewords from two different TRPs.

Hereinabove, example methods of receiving multi-instance CSI reporting at the network side are described in brief hereinbefore with reference to FIGS. 24 to 27. However, it can be understood that operations at the network device are substantially corresponding to those at the terminal device and thus for some details of operations, one may refer to description with reference to FIGS. 5 to 23.

FIG. 28 schematically illustrates a block diagram of an apparatus for multi-instance CSI reporting at a terminal device according to an embodiment of the present disclosure. The apparatus 2800 can be implemented at a terminal device, for example UE or other like terminal devices.

As illustrated in FIG. 2800, the apparatus 2800 may include an instance dropping module 2801 and a collision processing module 2802. The instance dropping module 2801 may be configured to drop, in response to a collision of an instance of a CSI report with another CSI report having a higher priority than the instance of CSI report, the instance of the CSI report. The collision processing module 2802 may be configured to process the collision by any one of: discarding all following instances of the CSI report; retransmitting the instance of the CSI report on a next transmission occasion for an instance of the CSI report and transmitting following instances of the CSI report until a new CSI report; continuing transmitting following instance of the CSI report; or retransmitting the instance of the CSI report with a time offset relative to a transmission occasion for the instance of the CSI report.

In an embodiment of the present disclosure, apparatus 2800 may additionally or alternatively include a report resuming module 2803. The report resuming module 2803 may be configured to resume transmission of the CSI report from a first instance of the CSI report in case of a bandwidth part (BWP) switching.

In another embodiment of the present disclosure, apparatus 2800 may additionally or alternatively include an activation/deactivation signaling receiving module 2804. The activation/deactivation signaling receiving module 2804 may be configured to receive an activation or deactivation signaling for a multi-instance CSI reporting, the activation or deactivation signaling being valid for related instances of the CSI report.

In a further embodiment of the present disclosure, apparatus 2800 may additionally or alternatively include an instance number configuration receiving module 2805. The instance number configuration receiving module 2805 may be configured to receive a CSI report instance number configuration via a RRC signaling, wherein the CSI report instance number configuration indicates the number of related instances of the CSI report.

In a still further embodiment of the present disclosure, apparatus 2800 may additionally or alternatively include a resource allocation receiving module 2806. The resource allocation receiving module 2806 may be configured to receive a resource configuration for each instance of the CSI reporting via RRC signaling. Or alternatively, in a yet further embodiment of the present disclosure, apparatus 2800 may further comprise a DCI receiving module 2807, which may be configured to receive a downlink control indication (DCI) granting a multi-slot uplink transmission for instances of the CSI report.

In another embodiment of the present disclosure, apparatus 2800 may additionally or alternatively include a SB set configuration receiving module 2808. The SB set configuration receiving module 2808 may be configured to receive a sub-band set configuration for an instance of the CSI report, the sub-band set configuration indicating information on size of sub-band set and indices of sub-bands contained in the sub-band set.

In a further embodiment of the present disclosure, apparatus 2800 may additionally or alternatively include a SB set determination module 2809. The SB set determination module 2809 may be configured to determine a sub-band set based on the sub-band set configuration, a sub-band bitmap and the number of instances of the CSI report.

In a still further embodiment of the present disclosure, apparatus 2800 may additionally or alternatively include an SB/SB set selection module 2810 and an instance transmission module 2811. The SB/SB set selection module 2810 may be configured to select at least one sub-band or sub-band set for an instance of a CSI report based on channel conditions. The instance transmission module 2811 may be configured to transmit the instance of the CSI report including CSI information on the selected at least one sub-band or sub-band set.

In a yet further embodiment of the present disclosure, apparatus 2800 may additionally or alternatively include a CW based instance transmission module 2812. The CW based instance transmission module 2812 may be configured to transmit two instances of a CSI report corresponding to two downlink codewords, each of the two instances of the CSI report containing a CSI part for transmitting a corresponding one of the two downlink codewords.

In an embodiment of the present disclosure, the two downlink codewords may be received from different downlink layers of the same transmission/reception point (TRP). In another embodiment of the present disclosure, the two downlink codewords may be received from two different TRPs.

FIG. 29 schematically illustrates a block diagram of an apparatus for receiving multi-instance CSI report at a network device according to an embodiment of the present disclosure. The Apparatus 2900 could be implemented on the network device or node for example gNB, or other like network devices.

As illustrated in FIG. 29, apparatus 2900 may include a CSI report receiving module 2901. The CSI report receiving module 2901 may be configured to perform, in case of a collision of an instance of a CSI report with another CSI report having a priority higher than the instance of the CSI report, receiving of the CSI report by any one of: discarding both the instance of the CSI report and all following instances of the CSI report; receiving a retransmission of the instance of the CSI report on a next transmission occasion for an instance of the CSI report and receiving following instances of the CSI report until a new CSI report; discarding the instance of the CSI report and receiving following instances of the CSI report, or receiving a retransmission of the instance of the CSI report with a time offset relative to a transmission occasion for the instance of the CSI report.

In an embodiment of the present disclosure, apparatus 2900 may additionally or alternatively include a report receiving resuming module 2903, which can be configured to resume receiving of the CSI report from a first instance of the CSI report in case of a bandwidth part (BWP) switching.

In another embodiment of the present disclosure, apparatus 2900 may additionally or alternatively include an activation/deactivation signaling transmission module 2904, which is configured to transmit an activation or deactivation signaling for a multi-instance CSI reporting, the activation or deactivation signaling being valid for related instances of the CSI report.

In a further embodiment of the present disclosure, apparatus 2900 may additionally or alternatively include an instance number configuration transmission module 2905. The instance number configuration transmission module 2905 may be configured to transmit a CSI report instance number configuration via a RRC signaling, wherein the CSI report instance number configuration indicates the number of related instances of the CSI report.

In a still further embodiment of the present disclosure, apparatus 2900 may additionally or alternatively include resource configuration transmission module 2906, which could be configured to transmit a resource configuration for each instance of the CSI reporting via RRC signaling.

In a yet further embodiment of the present disclosure, apparatus 2900 may additionally or alternatively include a DCI transmission module 2906, which could be configured to transmit a downlink control indication (DCI) granting a multi-slot uplink transmission for instances of the CSI report.

In another embodiment of the present disclosure, apparatus 2900 may additionally or alternatively a SB set configuration transmission module 2908, which could be configured to transmit a sub-band set configuration for an instance of the CSI report, the sub-band set configuration indicating information on size of sub-band set and indices of sub-bands contained in the sub-band set.

In a further embodiment of the present disclosure, apparatus 2900 may additionally or alternatively an instance receiving module 2911, which could be configured to receive an instance of a CSI report including CSI information on a sub-band or sub-band set selected based on channel conditions.

In a still further embodiment of the present disclosure, apparatus 2900 may additionally or alternatively a CW based instance receiving module 2912, which could be configured to receive two instances of a CSI report corresponding to two downlink codewords, each of the two instances of the CSI report containing a CSI part for transmitting a corresponding one of the two downlink codewords.

In an embodiment of the present disclosure, the two downlink codewords may be transmitted from different downlink layers of the same transmission/reception point (TRP). In another embodiment of the present disclosure, the two downlink codewords may be transmitted from two different TRPs.

Hereinbefore, apparatuses 2800 to 2900 are described with reference to FIGS. 28 and 29 in brief. It can be noted that the apparatuses 2800 to 2900 may be configured to implement functionalities as described with reference to FIGS. 5 to 27. Therefore, for details about the operations of modules in these apparatuses, one may refer to those descriptions made with respect to the respective steps of the methods with reference to FIGS. 5 to 27.

It is further noted that components of apparatuses 2800 to 2900 may be embodied in hardware, software, firmware, and/or any combination thereof. For example, the components of apparatuses 2800 to 2900 may be respectively implemented by a circuit, a processor or any other appropriate selection device.

Those skilled in the art will appreciate that the aforesaid examples are only for illustration not limitation and the present disclosure is not limited thereto; one can readily conceive many variations, additions, deletions and modifications from the teaching provided herein and all these variations, additions, deletions and modifications fall the protection scope of the present disclosure.

In addition, in some embodiment of the present disclosure, apparatuses 2800 to 2900 may include at least one processor. The at least one processor suitable for use with embodiments of the present disclosure may include, by way of example, both general and special purpose processors already known or developed in the future. Apparatuses 2800 to 2900 may further include at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause apparatuses 2800 to 2900 to at least perform operations according to the method as discussed with reference to FIGS. 5 to 27 respectively.

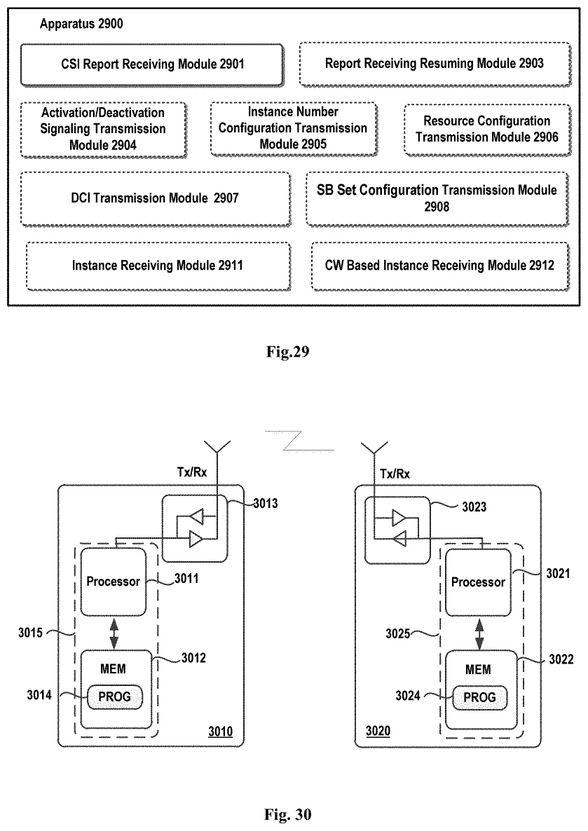

FIG. 30 schematically illustrates a simplified block diagram of an apparatus 3010 that may be embodied as or comprised in a terminal device like UE, and an apparatus 3020 that may be embodied as or comprised in a network device like gNB as described herein.

The apparatus 3010 comprises at least one processor 3011, such as a data processor (DP) and at least one memory (MEM) 3012 coupled to the processor 3011. The apparatus 3010 may further include a transmitter TX and receiver RX 3013 coupled to the processor 3011, which may be operable to communicatively connect to the apparatus 3020. The MEM 3012 stores a program (PROG) 3014. The PROG 3014 may include instructions that, when executed on the associated processor 3011, enable the apparatus 3010 to operate in accordance with embodiments of the present disclosure, for example methods 500, 900, 1100, 1500 and 2000. A combination of the at least one processor 3011 and the at least one MEM 3012 may form processing means 3015 adapted to implement various embodiments of the present disclosure.

The apparatus 3020 comprises at least one processor 3011, such as a DP, and at least one MEM 3022 coupled to the processor 3011. The apparatus 3020 may further include a suitable TX/RX 3023 coupled to the processor 3021, which may be operable for wireless communication with the apparatus 3010. The MEM 3022 stores a PROG 3024. The PROG 3024 may include instructions that, when executed on the associated processor 3021, enable the apparatus 3020 to operate in accordance with the embodiments of the present disclosure, for example to perform method 2400, 2500, 2600 and 2700. A combination of the at least one processor 3021 and the at least one MEM 3022 may form processing means 3025 adapted to implement various embodiments of the present disclosure.

Various embodiments of the present disclosure may be implemented by computer program executable by one or more of the processors 3011, 3021, software, firmware, hardware or in a combination thereof.

The MEMs 3012 and 3022 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 3011 and 3021 may be of any type suitable to the local technical environment, and may include one or more of general purpose computers, special purpose computers, microprocessors, digital signal processors DSPs and processors based on multicore processor architecture, as non-limiting examples.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method for multiple-instance channel state information (CSI) reporting in a wireless communication system, comprising:
in response to a collision of an instance of a CSI report with another CSI report having a higher priority than the instance of CSI report, dropping the instance of the CSI report; and
processing the collision by any one of:
discarding all following instances of the CSI report;
retransmitting the instance of the CSI report on a next transmission occasion for an instance of the CSI report and transmitting following instances of the CSI report until a new CSI report;
continuing transmitting following instance of the CSI report; or
retransmitting the instance of the CSI report with a time offset relative to a transmission occasion for the instance of the CSI report.

2. The method of claim 1, further comprising:
resuming transmission of the CSI report from a first instance of the CSI report in case of a bandwidth part (BWP) switching.

3. The method of claim 1, further comprising:
receiving an activation or deactivation signaling for a multi-instance CSI reporting, the activation or deactivation signaling being valid for related instances of the CSI report.

4. The method of claim 3, further comprising:
receiving a CSI report instance number configuration via a RRC signaling, wherein the CSI report instance number configuration indicates the number of related instances of the CSI report.

5. The method of claim 1, further comprising any of:
receiving a resource configuration for each instance of the CSI reporting via RRC signaling; or
receiving a downlink control indication (DCI) granting a multi-slot uplink transmission for instances of the CSI report.

6. The method of claim 1, further comprising:
receiving a sub-band set configuration for an instance of the CSI report, the sub-band set configuration indicating information on size of sub-band set and indices of sub-bands contained in the sub-band set.

7. The method of claim 6, further comprising:
determining a sub-band set based on the sub-band set configuration, a sub-band bitmap and the number of instances of the CSI report.

8. The method of claim 1, further comprising:
selecting at least one sub-band or sub-band set for an instance of a CSI report based on channel conditions; and
transmitting the instance of the CSI report including CSI information on the selected at least one sub-band or sub-band set.

9. The method of claim 1, further comprising:
transmitting two instances of a CSI report corresponding to two downlink codewords, each of the two instances of the CSI report containing a CSI part for transmitting a corresponding one of the two downlink codewords.

10. The method of claim 9, wherein the two downlink codewords are received from any of:
different downlink layers of the same transmission/reception point (TRP); or
two different TRPs.

11. A method for receiving multiple-instance channel state information (CSI) report in a wireless communication system, comprising:
in case of a collision of an instance of a CSI report with another CSI report having a priority higher than the instance of the CSI report, performing receiving of the CSI report by any one of:
discarding both the instance of the CSI report and all following instances of the CSI report;
receiving a retransmission of the instance of the CSI report on a next transmission occasion for an instance of the CSI report and receiving following instances of the CSI report until a new CSI report;
discarding the instance of the CSI report and receiving following instances of the CSI report, or
receiving a retransmission of the instance of the CSI report with a time offset relative to a transmission occasion for the instance of the CSI report.

12. The method of claim 11, further comprising:
resuming receiving of the CSI report from a first instance of the CSI report in case of a bandwidth part (BWP) switching.

13. The method of claim 11, further comprising:
transmitting an activation or deactivation signaling for a multi-instance CSI reporting, the activation or deactivation signaling being valid for related instances of the CSI report.

14. The method of claim 13, further comprising:
transmitting a CSI report instance number configuration via a RRC signaling, wherein the CSI report instance number configuration indicates the number of related instances of the CSI report.

15. The method of claim 11, further comprising any of
transmitting a resource configuration for each instance of the CSI reporting via RRC signaling; or
transmitting a downlink control indication (DCI) granting a multi-slot uplink transmission for instances of the CSI report.

16. The method of claim 11, further comprising:
transmitting a sub-band set configuration for an instance of the CSI report, the sub-band set configuration indicating information on size of sub-band set and indices of sub-bands contained in the sub-band set.

17. The method of claim 16, further comprising:
receiving an instance of a CSI report including CSI information on a sub-band or sub-band set selected based on channel conditions.

18. The method of claim 11, further comprising:
receiving two instances of a CSI report corresponding to two downlink codewords, each of the two instances of the CSI report containing a CSI part for transmitting a corresponding one of the two downlink codewords.

19. The method of claim 18, further comprising transmitting the two downlink codewords from any of:
different downlink layers of the same transmission/reception point (TRP); or
two different TRPs.

20-23. (canceled)
